(19) United States
(12) Patent Application Publication
(10) Pub. No.: US 2023/0148403 A1
(43) Pub. Date: May 11, 2023

(54) PREAMBLE FOR EXTENDED RANGE (ER) PPDU TRANSMISSION OVER WIDE CHANNEL BANDWIDTHS

(71) Applicants: Juan Fang, Portland, OR (US); Qinghua Li, San Ramon, CA (US); Po-Kai Huang, San Jose, CA (US); Thomas J. Kenney, Portland, OR (US); Robert J. Stacey, Portland, OR (US)

(72) Inventors: Juan Fang, Portland, OR (US); Qinghua Li, San Ramon, CA (US); Po-Kai Huang, San Jose, CA (US); Thomas J. Kenney, Portland, OR (US); Robert J. Stacey, Portland, OR (US)

(21) Appl. No.: 18/071,811

(22) Filed: Nov. 30, 2022

(51) Int. Cl. H04L 5/00; H04L 25/02

(52) U.S. Cl. CPC H04L 5/0048; H04L 5/0064; H04L 25/0202; H04L 5/006

(57) ABSTRACT

A physical layer protocol data unit (PPDU) may include legacy preamble fields followed by a universal signal field (U-SIG). For an extended range (ER) transmission, the U-SIG is encoded to indicate via a bit whether the PPDU is an ER PPDU or a non-ER PPDU. When the U-SIG is encoded to indicate that the PPDU is an ER PPDU, the PPDU may include ER preamble fields following the U-SIG and an ER data field following the ER preamble fields. The ER preamble fields may comprise pre-ER modulated fields followed by ER modulated fields. The pre-ER modulate fields may comprise an ER short training field (ER-STF) followed by an ER long training field (ER-LTF) followed by an ER signal field (ER-SIG). The ER modulated fields may comprise at least the ER data field.

### TECHNICAL FIELD

Embodiments pertain to wireless communications. Some embodiments relate wireless local area networks (WLANs) that operate in accordance with the IEEE 802.11 standards. Some embodiments relate to IEEE 802.11be Extremely High Throughput (EHT) (i.e., the IEEE P802.11-Task Group BE EHT) (Wi-Fi 7). Some embodiments relate to next generation Wi-Fi (Wi-Fi 8).

### BACKGROUND

One issue with communicating data over a wireless network is range. For longer-range transmission, lower received signal levels make it difficult for a receiver to properly detect and decode packets. This is particularly an issue with wideband transmissions in WLANs as a receiving station (STA) may not be able to detect and/or properly decode a preamble of a physical layer protocol data unit (PPDU). Thus what is needed is a PPDU for extended range communications.

### BRIEF DESCRIPTION OF THE DRAWINGS

FIG. 1 is a block diagram of a radio architecture, in accordance with some embodiments.

FIG. 2 illustrates a front-end module circuitry for use in the radio architecture of FIG. 1, in accordance with some embodiments.

FIG. 3 illustrates a radio IC circuitry for use in the radio architecture of FIG. 1, in accordance with some embodiments.

FIG. 4 illustrates a baseband processing circuitry for use in the radio architecture of FIG. 1, in accordance with some embodiments.

FIG. 5 illustrates a WLAN, in accordance with some embodiments.

FIG. 6 illustrates an extended range (ER) PPDU, in accordance with some embodiments.

FIG. 7 illustrates an ER PPDU, in accordance with some other embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

In some embodiments, a physical layer protocol data unit (PPDU) may include legacy preamble fields followed by a universal signal field (U-SIG). For an extended range (ER) transmission, the U-SIG may be encoded to indicate via a bit whether the PPDU is an ER PPDU or a non-ER PPDU. When the U-SIG is encoded to indicate that the PPDU is an ER PPDU, the PPDU may include ER preamble fields following the U-SIG and an ER data field following the ER preamble fields. The ER preamble fields may comprise pre-ER modulated fields followed by ER modulated fields. The pre-ER modulate fields may comprise an ER short training field (ER-STF) followed by an ER long training field (ER-LTF) followed by an ER signal field (ER-SIG). The ER modulated fields may comprise at least the ER data field. These embodiments, as well as others, are described in more detail below.

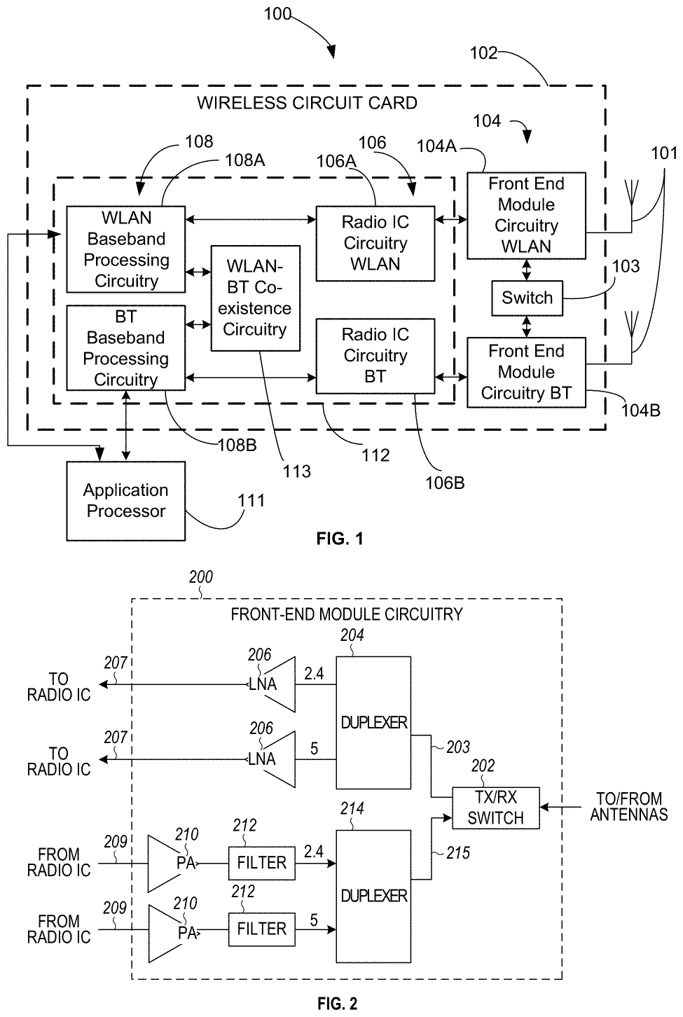

FIG. 1 is a block diagram of a radio architecture 100 in accordance with some embodiments. Radio architecture 100 may include radio front-end module (FEM) circuitry 104, radio IC circuitry 106 and baseband processing circuitry 108. Radio architecture 100 as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 104 may include a WLAN or Wi-Fi FEM circuitry 104A and a Bluetooth (BT) FEM circuitry 104B. The WLAN FEM circuitry 104A may include a receive signal path comprising circuitry configured to operate on WLAN RF signals received from one or more antennas 101, to amplify the received signals and to provide the amplified versions of the received signals to the WLAN radio IC circuitry 106A for further processing. The BT FEM circuitry 104B may include a receive signal path which may include circuitry configured to operate on BT RF signals received from one or more antennas 101, to amplify the received signals and to provide the amplified versions of the received signals to the BT radio IC circuitry 106B for further processing. FEM circuitry 104A may also include a transmit signal path which may include circuitry configured to amplify WLAN signals provided by the radio IC circuitry 106A for wireless transmission by one or more of the antennas 101. In addition, FEM circuitry 104B may also include a transmit signal path which may include circuitry configured to amplify BT signals provided by the radio IC circuitry 106B for wireless transmission by the one or more antennas. In the embodiment of FIG. 1, although FEM 104A and FEM 104B are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 106 as shown may include WLAN radio IC circuitry 106A and BT radio IC circuitry 106B. The WLAN radio IC circuitry 106A may include a receive signal path which may include circuitry to down-convert WLAN RF signals received from the FEM circuitry 104A and provide baseband signals to WLAN baseband processing circuitry 108A. BT radio IC circuitry 106B may in turn include a receive signal path which may include circuitry to down-convert BT RF signals received from the FEM circuitry 104B and provide baseband signals to BT baseband processing circuitry 108B. WLAN radio IC circuitry 106A may also include a transmit signal path which may include circuitry to up-convert WLAN baseband signals provided by the WLAN baseband processing circuitry 108A and provide WLAN RF output signals to the FEM circuitry 104A for subsequent wireless transmission by the one or more antennas 101. BT radio IC circuitry 106B may also include a transmit signal path which may include circuitry to up-convert BT baseband signals provided by the BT baseband processing circuitry 108B and provide BT RF output signals to the FEM circuitry 104B for subsequent wireless transmission by the one or more antennas 101. In the embodiment of FIG. 1, although radio IC circuitries 106A and 106B are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 108 may include a WLAN baseband processing circuitry 108A and a BT baseband processing circuitry 108B. The WLAN baseband processing circuitry 108A may include a memory, such as, for example, a set of RAM arrays in a Fast Fourier Transform or Inverse Fast Fourier Transform block (not shown) of the WLAN baseband processing circuitry 108A. Each of the WLAN baseband circuitry 108A and the BT baseband circuitry 108B may further include one or more processors and control logic to process the signals received from the corresponding WLAN or BT receive signal path of the radio IC circuitry 106, and to also generate corresponding WLAN or BT baseband signals for the transmit signal path of the radio IC circuitry 106. Each of the baseband processing circuitries 108A and 108B may further include physical layer (PHY) and medium access control layer (MAC) circuitry and may further interface with application processor 111 for generation and processing of the baseband signals and for controlling operations of the radio IC circuitry 106.

Referring still to FIG. 1, according to the shown embodiment, WLAN-BT coexistence circuitry 113 may include logic providing an interface between the WLAN baseband circuitry 108A and the BT baseband circuitry 108B to enable use cases requiring WLAN and BT coexistence. In addition, a switch 103 may be provided between the WLAN FEM circuitry 104A and the BT FEM circuitry 104B to allow switching between the WLAN and BT radios according to application needs. In addition, although the antennas 101 are depicted as being respectively connected to the WLAN FEM circuitry 104A and the BT FEM circuitry 104B, embodiments include within their scope the sharing of one or more antennas as between the WLAN and BT FEMs, or the provision of more than one antenna connected to each of FEM 104A or 104B.

In some embodiments, the front-end module circuitry 104, the radio IC circuitry 106, and baseband processing circuitry 108 may be provided on a single radio card, such as wireless radio card 102. In some other embodiments, the one or more antennas 101, the FEM circuitry 104 and the radio IC circuitry 106 may be provided on a single radio card. In some other embodiments, the radio IC circuitry 106 and the baseband processing circuitry 108 may be provided on a single chip or integrated circuit (IC), such as IC 112.

In some embodiments, the wireless radio card 102 may include a WLAN radio card and may be configured for Wi-Fi communications, although the scope of the embodiments is not limited in this respect. In some of these embodiments, the radio architecture 100 may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal sub carriers.

In some of these multicarrier embodiments, radio architecture 100 may be part of a Wi-Fi communication station (STA) such as a wireless access point (AP), a base station or a mobile device including a Wi-Fi device. In some of these embodiments, radio architecture 100 may be configured to transmit and receive signals in accordance with specific communication standards and/or protocols, such as any of the Institute of Electrical and Electronics Engineers (IEEE) standards including, IEEE 802.11n-2009, IEEE 802.11-2012, IEEE 802.11-2016, IEEE 802.11ac, IEEE 802.11ax, and/or IEEE P802.11be standards and/or proposed specifications for WLANs, although the scope of embodiments is not limited in this respect. Radio architecture 100 may also be suitable to transmit and/or receive communications in accordance with other techniques and standards.

In some embodiments, the radio architecture 100 may be configured for high-efficiency (HE) Wi-Fi (HEW) communications in accordance with the IEEE 802.11ax standard. In some embodiments, the radio architecture 100 may be configured for Extremely High Throughput (EHT) communications in accordance with the IEEE 802.11be standard. In these embodiments, the radio architecture 100 may be configured to communicate in accordance with an OFDMA technique, although the scope of the embodiments is not limited in this respect. In some embodiments, the radio architecture 100 may be configured for next generation vehicle-to-everything (NGV) communications in accordance with the IEEE 802.11bd standard and one or more stations including AP 502 may be next generation vehicle-to-everything (NGV) stations (STAs).

In some other embodiments, the radio architecture 100 may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 1, the BT baseband circuitry 108B may be compliant with a Bluetooth (BT) connectivity standard such as Bluetooth, Bluetooth 4.0 or Bluetooth 5.0, or any other iteration of the Bluetooth Standard. In embodiments that include BT functionality as shown for example in FIG. 1, the radio architecture 100 may be configured to establish a BT synchronous connection oriented (SCO) link and/or a BT low energy (BT LE) link. In some of the embodiments that include functionality, the radio architecture 100 may be configured to establish an extended SCO (eSCO) link for BT communications, although the scope of the embodiments is not limited in this respect. In some of these embodiments that include a BT functionality, the radio architecture may be configured to engage in a BT Asynchronous Connection-Less (ACL) communications, although the scope of the embodiments is not limited in this respect. In some embodiments, as shown in FIG. 1, the functions of a BT radio card and WLAN radio card may be combined on a single wireless radio card, such as single wireless radio card 102, although embodiments are not so limited, and include within their scope discrete WLAN and BT radio cards.

In some embodiments, the radio-architecture 100 may include other radio cards, such as a cellular radio card configured for cellular (e.g., 3GPP such as LTE, LTE-Advanced or 5G communications).

In some IEEE 802.11 embodiments, the radio architecture 100 may be configured for communication over various channel bandwidths including bandwidths having center frequencies of about 900 MHz, 2.4 GHz, 5 GHz, and bandwidths of about 1 MHz, 2 MHz, 2.5 MHz, 4 MHz, 5 MHz, 8 MHz, 10 MHz, 16 MHz, 20 MHz, 40 MHz, 80 MHz (with contiguous bandwidths) or 80+80 MHz (160 MHz) (with non-contiguous bandwidths). In some embodiments, a 320 MHz channel bandwidth may be used. The scope of the embodiments is not limited with respect to the above center frequencies however.

FIG. 2 illustrates FEM circuitry 200 in accordance with some embodiments. The FEM circuitry 200 is one example of circuitry that may be suitable for use as the WLAN and/or BT FEM circuitry 104A/104B (FIG. 1), although other circuitry configurations may also be suitable.

In some embodiments, the FEM circuitry 200 may include a TX/RX switch 202 to switch between transmit mode and receive mode operation. The FEM circuitry 200 may include a receive signal path and a transmit signal path. The receive signal path of the FEM circuitry 200 may include a low-noise amplifier (LNA) 206 to amplify received RF signals 203 and provide the amplified received RF signals 207 as an output (e.g., to the radio IC circuitry 106 (FIG. 1)). The transmit signal path of the circuitry 200 may include a power amplifier (PA) to amplify input RF signals 209 (e.g., provided by the radio IC circuitry 106), and one or more filters 212, such as band-pass filters (BPFs), low-pass filters (LPFs) or other types of filters, to generate RF signals 215 for subsequent transmission (e.g., by one or more of the antennas 101 (FIG. 1)).

In some dual-mode embodiments for Wi-Fi communication, the FEM circuitry 200 may be configured to operate in either the 2.4 GHz frequency spectrum or the 5 GHz frequency spectrum. In these embodiments, the receive signal path of the FEM circuitry 200 may include a receive signal path duplexer 204 to separate the signals from each spectrum as well as provide a separate LNA 206 for each spectrum as shown. In these embodiments, the transmit signal path of the FEM circuitry 200 may also include a power amplifier 210 and a filter 212, such as a BPF, a LPF or another type of filter for each frequency spectrum and a transmit signal path duplexer 214 to provide the signals of one of the different spectrums onto a single transmit path for subsequent transmission by the one or more of the antennas 101 (FIG. 1). In some embodiments, BT communications may utilize the 2.4 GHZ signal paths and may utilize the same FEM circuitry 200 as the one used for WLAN communications.

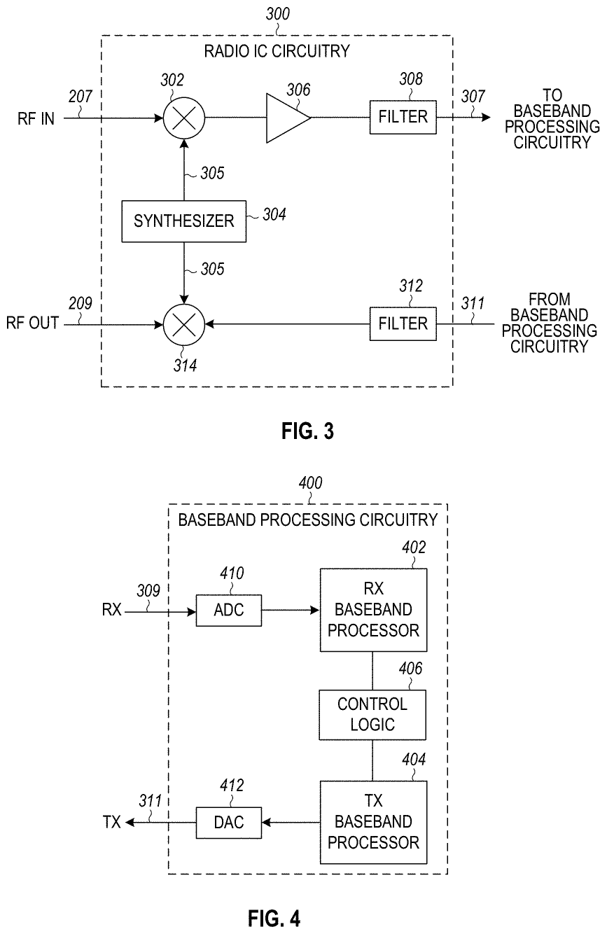

FIG. 3 illustrates radio IC circuitry 300 in accordance with some embodiments. The radio IC circuitry 300 is one example of circuitry that may be suitable for use as the WLAN or BT radio IC circuitry 106A/106B (FIG. 1), although other circuitry configurations may also be suitable.

In some embodiments, the radio IC circuitry 300 may include a receive signal path and a transmit signal path. The receive signal path of the radio IC circuitry 300 may include at least mixer circuitry 302, such as, for example, down-conversion mixer circuitry, amplifier circuitry 306 and filter circuitry 308. The transmit signal path of the radio IC circuitry 300 may include at least filter circuitry 312 and mixer circuitry 314, such as, for example, up-conversion mixer circuitry. Radio IC circuitry 300 may also include synthesizer circuitry 304 for synthesizing a frequency 305 for use by the mixer circuitry 302 and the mixer circuitry 314. The mixer circuitry 302 and/or 314 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 3 illustrates only a simplified version of a radio IC circuitry, and may include, although not shown, embodiments where each of the depicted circuitries may include more than one component. For instance, mixer circuitry 320 and/or 314 may each include one or more mixers, and filter circuitries 308 and/or 312 may each include one or more filters, such as one or more BPFs and/or LPFs according to application needs. For example, when mixer circuitries are of the direct-conversion type, they may each include two or more mixers.

In some embodiments, mixer circuitry 302 may be configured to down-convert RF signals 207 received from the FEM circuitry 104 (FIG. 1) based on the synthesized frequency 305 provided by synthesizer circuitry 304. The amplifier circuitry 306 may be configured to amplify the down-converted signals and the filter circuitry 308 may include a LPF configured to remove unwanted signals from the down-converted signals to generate output baseband signals 307. Output baseband signals 307 may be provided to the baseband processing circuitry 108 (FIG. 1) for further processing. In some embodiments, the output baseband signals 307 may be zero-frequency baseband signals, although this is not a requirement. In some embodiments, mixer circuitry 302 may comprise passive mixers, although the scope of the embodiments is not limited in this respect.

In some embodiments, the mixer circuitry 314 may be configured to up-convert input baseband signals 311 based on the synthesized frequency 305 provided by the synthesizer circuitry 304 to generate RF output signals 209 for the FEM circuitry 104. The baseband signals 311 may be provided by the baseband processing circuitry 108 and may be filtered by filter circuitry 312. The filter circuitry 312 may include a LPF or a BPF, although the scope of the embodiments is not limited in this respect.

In some embodiments, the mixer circuitry 302 and the mixer circuitry 314 may each include two or more mixers and may be arranged for quadrature down-conversion and/or up-conversion respectively with the help of synthesizer 304. In some embodiments, the mixer circuitry 302 and the mixer circuitry 314 may each include two or more mixers each configured for image rejection (e.g., Hartley image rejection). In some embodiments, the mixer circuitry 302 and the mixer circuitry 314 may be arranged for direct down-conversion and/or direct up-conversion, respectively. In some embodiments, the mixer circuitry 302 and the mixer circuitry 314 may be configured for super-heterodyne operation, although this is not a requirement.

Mixer circuitry 302 may comprise, according to one embodiment: quadrature passive mixers (e.g., for the in-phase (I) and quadrature phase (Q) paths). In such an embodiment, RF input signal 207 from FIG. 3 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (f_{LO}) from a local oscillator or a synthesizer, such as LO frequency 305 of synthesizer 304 (FIG. 3). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have a 25% duty cycle and a 50% offset. In some embodiments, each branch of the mixer circuitry (e.g., the in-phase (I) and quadrature phase (Q) path) may operate at a 25% duty cycle, which may result in a significant reduction is power consumption.

The RF input signal 207 (FIG. 2) may comprise a balanced signal, although the scope of the embodiments is not limited in this respect. The I and Q baseband output signals may be provided to low-nose amplifier, such as amplifier circuitry 306 (FIG. 3) or to filter circuitry 308 (FIG. 3).

In some embodiments, the output baseband signals 307 and the input baseband signals 311 may be analog baseband signals, although the scope of the embodiments is not limited in this respect. In some alternate embodiments, the output baseband signals 307 and the input baseband signals 311 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 304 may be a fractional-N synthesizer or a fractional N/N+1 synthesizer, although the scope of the embodiments is not limited in this respect as other types of frequency synthesizers may be suitable. For example, synthesizer circuitry 304 may be a delta-sigma synthesizer, a frequency multiplier, or a synthesizer comprising a phase-locked loop with a frequency divider. According to some embodiments, the synthesizer circuitry 304 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 304 may be provided by a voltage controlled oscillator (VCO), although that is not a requirement. A divider control input may further be provided by either the baseband processing circuitry 108 (FIG. 1) or application processor 111 (FIG. 1) depending on the desired output frequency 305. In some embodiments, a divider control input (e.g., N) may be determined from a look-up table (e.g., within a Wi-Fi card) based on a channel number and a channel center frequency as determined or indicated by application processor 111.

In some embodiments, synthesizer circuitry 304 may be configured to generate a carrier frequency as the output frequency 305, while in other embodiments, the output frequency 305 may be a fraction of the carrier frequency (e.g., one-half the carrier frequency, one-third the carrier frequency). In some embodiments, the output frequency 305 may be a LO frequency (f_{LO}).

FIG. 4 illustrates a functional block diagram of baseband processing circuitry 400 in accordance with some embodiments. The baseband processing circuitry 400 is one example of circuitry that may be suitable for use as the baseband processing circuitry 108 (FIG. 1), although other circuitry configurations may also be suitable. The baseband processing circuitry 400 may include a receive baseband processor (RX BBP) 402 for processing receive baseband signals 309 provided by the radio IC circuitry 106 (FIG. 1) and a transmit baseband processor (TX BBP) 404 for generating transmit baseband signals 311 for the radio IC circuitry 106. The baseband processing circuitry 400 may also include control logic 406 for coordinating the operations of the baseband processing circuitry 400.

In some embodiments (e.g., when analog baseband signals are exchanged between the baseband processing circuitry 400 and the radio IC circuitry 106), the baseband processing circuitry 400 may include ADC 410 to convert analog baseband signals received from the radio IC circuitry 106 to digital baseband signals for processing by the RX BBP 402. In these embodiments, the baseband processing circuitry 400 may also include DAC 412 to convert digital baseband signals from the TX BBP 404 to analog baseband signals.

In some embodiments that communicate OFDM signals or OFDMA signals, such as through baseband processor 108A, the transmit baseband processor 404 may be configured to generate OFDM or OFDMA signals as appropriate for transmission by performing an inverse fast Fourier transform (IFFT). The receive baseband processor 402 may be configured to process received OFDM signals or OFDMA signals by performing an FFT. In some embodiments, the receive baseband processor 402 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 1, in some embodiments, the antennas 101 (FIG. 1) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 101 may each include a set of phased-array antennas, although embodiments are not so limited.

Although the radio-architecture 100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

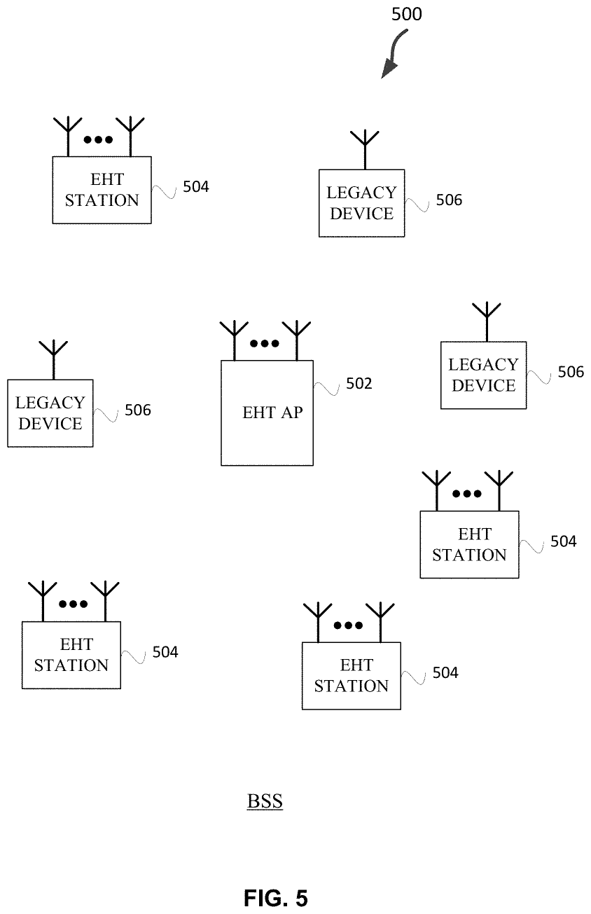

FIG. 5 illustrates a WLAN 500 in accordance with some embodiments. The WLAN 500 may comprise a basis service set (BSS) that may include an access point (AP) 502, which may be an AP, a plurality of stations 504, and a plurality of legacy (e.g., IEEE 802.11n/ac/ax) devices 506. In some embodiments, WLAN 500 may be configured for Extremely High Throughput (EHT) communications in accordance with the IEEE 802.11be standard and one or more stations including AP 502 may be EHT STAs. In some embodiments, WLAN 500 may be configured for next generation vehicle-to-everything (NGV) communications in accordance with the IEEE 802.11bd standard and one or more stations including AP 502 may be next generation vehicle-to-everything (NGV) stations (STAs).

The AP 502 may be an AP using the IEEE 802.11 to transmit and receive. The AP 502 may be a base station. The AP 502 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO). There may be more than one AP 502 that is part of an extended service set (ESS). A controller (not illustrated) may store information that is common to the more than one APs 502. IEEE P802.11be/D2.0, May 2022 is incorporated herein by reference.

The legacy devices 506 may operate in accordance with one or more of IEEE 802.11 a/b/g/n/ac/ad/af/ah/aj/ay, or another legacy wireless communication standard. The legacy devices 506 may be STAs or IEEE STAs. The STAs 504 may be wireless transmit and receive devices such as cellular telephone, portable electronic wireless communication devices, smart telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the STAs 504 may be termed high efficiency (HE) stations.

AP 502 may communicate with legacy devices 506 in accordance with legacy IEEE 802.11 communication techniques. In example embodiments, AP 502 may also be configured to communicate with STAs 504 in accordance with legacy IEEE 802.11 communication techniques.

In some embodiments, a frame may be configurable to have the same bandwidth as a channel. The frame may be a physical Layer Convergence Procedure (PLCP) Protocol Data Unit (PPDU). In some embodiments, there may be different types of PPDUs that may have different fields and different physical layers and/or different media access control (MAC) layers.

The bandwidth of a channel may be 20 MHz, 40 MHz, or 80 MHz, 160 MHz, 320 MHz contiguous bandwidths or an 80+80 MHz (160 MHz) non-contiguous bandwidth. In some embodiments, the bandwidth of a channel may be 1 MHz, 1.25 MHz, 2.03 MHz, 2.5 MHz, 4.06 MHz, 5 MHz and 10 MHz, or a combination thereof or another bandwidth that is less or equal to the available bandwidth may also be used. In some embodiments the bandwidth of the channels may be based on a number of active data subcarriers. In some embodiments the bandwidth of the channels is based on 26, 52, 106, 242, 484, 996, or 2×996 active data subcarriers or tones that are spaced by 20 MHz. In some embodiments the bandwidth of the channels is 256 tones spaced by 20 MHz. In some embodiments the channels are multiple of 26 tones or a multiple of 20 MHz. In some embodiments a 20 MHz channel may comprise 242 active data subcarriers or tones, which may determine the size of a Fast Fourier Transform (FFT). An allocation of a bandwidth or a number of tones or sub-carriers may be termed a resource unit (RU) allocation in accordance with some embodiments.

In some embodiments, the 26-subcarrier RU and 52-subcarrier RU are used in the 20 MHz, 40 MHz, 80 MHz, 160 MHz and 80+80 MHz OFDMA PPDU formats. In some embodiments, the 106-subcarrier RU is used in the 20 MHz, 40 MHz, 80 MHz, 160 MHz and 80+80 MHz OFDMA and MU-MIMO PPDU formats. In some embodiments, the 242-subcarrier RU is used in the 40 MHz, 80 MHz, 160 MHz and 80+80 MHz OFDMA and MU-MIMO PPDU formats. In some embodiments, the 484-subcarrier RU is used in the 80 MHz, 160 MHz and 80+80 MHz OFDMA and MU-MIMO PPDU formats. In some embodiments, the 996-subcarrier RU is used in the 160 MHz and 80+80 MHz OFDMA and MU-MIMO PPDU formats.

A frame may be configured for transmitting a number of spatial streams, which may be in accordance with MU-MIMO and may be in accordance with OFDMA. In other embodiments, AP 502, STA 504, and/or legacy device 506 may also implement different technologies such as code division multiple access (CDMA) 2000, CDMA 2000 1×, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HE and/or EHT communications. In accordance with some IEEE 802.11 embodiments (e.g., IEEE 802.11ax embodiments) a AP 502 may operate as a master station which may be arranged to contend for a wireless medium (e.g., during a contention period) to receive exclusive control of the medium for an control period. In some embodiments, the control period may be termed a transmission opportunity (TXOP). AP 502 may transmit a master-sync transmission, which may be a trigger frame or control and schedule transmission, at the beginning of the control period. AP 502 may transmit a time duration of TXOP and sub-channel information. During the control period, STAs 504 may communicate with AP 502 in accordance with a non-contention based multiple access technique such as OFDMA or MU-MIMO. This is unlike conventional WLAN communications in which devices communicate in accordance with a contention-based communication technique, rather than a multiple access technique. During the control period, the AP 502 may communicate with STAs 504 using one or more frames. During the control period, the STAs 504 may operate on a sub-channel smaller than the operating range of the AP 502. During the control period, legacy stations refrain from communicating. The legacy stations may need to receive the communication from the AP 502 to defer from communicating.

In accordance with some embodiments, during TXOP the STAs 504 may contend for the wireless medium with the legacy devices 506 being excluded from contending for the wireless medium during the master-sync transmission. In some embodiments the trigger frame may indicate an uplink (UL) and/or UL OFDMA TXOP. In some embodiments, the trigger frame may include a DL UL-MU-MIMO and/or DL OFDMA with a schedule indicated in a preamble portion of trigger frame.

In some embodiments, the multiple-access technique used during the TXOP may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique. In some embodiments, the multiple access technique may be a Code division multiple access (CDMA).

The AP 502 may also communicate with legacy stations 506 and/or non-legacy stations 504 in accordance with legacy IEEE 802.11 communication techniques. In some embodiments, the AP 502 may also be configurable to communicate with STAs 504 outside the TXOP in accordance with legacy IEEE 802.11 communication techniques, although this is not a requirement.

In some embodiments station 504 may be a “group owner” (GO) for peer-to-peer modes of operation. A wireless device may be a Station 502 or a AP 502.

In some embodiments, the station 504 and/or AP 502 may be configured to operate in accordance with IEEE 802.11mc. In example embodiments, the radio architecture of FIG. 1 is configured to implement the station 504 and/or the AP 502. In example embodiments, the front-end module circuitry of FIG. 2 is configured to implement the station 504 and/or the AP 502. In example embodiments, the radio IC circuitry of FIG. 3 is configured to implement the station 504 and/or the AP 502. In example embodiments, the base-band processing circuitry of FIG. 4 is configured to implement the station 504 and/or the AP 502.

In example embodiments, the stations 504, AP 502, an apparatus of the stations 504, and/or an apparatus of the AP 502 may include one or more of the following: the radio architecture of FIG. 1, the front-end module circuitry of FIG. 2, the radio IC circuitry of FIG. 3, and/or the base-band processing circuitry of FIG. 4.

In example embodiments, the radio architecture of FIG. 1, the front-end module circuitry of FIG. 2, the radio IC circuitry of FIG. 3, and/or the base-band processing circuitry of FIG. 4 may be configured to perform the methods and operations/functions herein.

In example embodiments, the station 504 and/or the AP 502 are configured to perform the methods and operations/functions described herein. In example embodiments, an apparatus of the station 504 and/or an apparatus of the AP 502 are configured to perform the methods and functions described herein. The term Wi-Fi may refer to one or more of the IEEE 802.11 communication standards. AP and STA may refer to access point 502 and/or station 504 as well as legacy devices 506.

In some embodiments, a AP STA may refer to a AP 502 and a STAs 504 that is operating a APs 502. In some embodiments, when an STA 504 is not operating as a AP, it may be referred to as a non-AP STA or non-AP. In some embodiments, STA 504 may be referred to as either a AP STA or a non-AP.
Although the IEEE 802.11b standard is more than 20 years old, it is still widely used for long range communications in WLANs. However, it has certain downsides, e.g., weak channel coding and the coexistence issue with mainstream OFDM-based systems. There is a need to replace it by an OFDM-based system with similar range coverage, which is about 9 dB better than the existing 20 MHz MCS 0 of OFDM-based 802.11a, the 6 Mbps mode.

The high-efficiency (HE) extended range (ER) single user (SU) PPDU format was defined in the IEEE 802.11ax standards. Both the STF and the LTF are boosted with 3 dB and both the HE-SIG-A1 and the HE-SIG-A2 are repeated Twice, which is HE-SIG-A1, HE-SIG-A1-R, HE-SIG-A2 and HE-SIG-A2-R. The HE-SIG-A1-R is modulated with QBPSK to indicate the extended range mode. For the data, the HE ER SU PPDU supports only a single 242-tone or 106-tone RU. An HE ER SU PPDU with a 242-tone RU shall be transmitted with only the MCS 0, 1 and 2 with single spatial stream. An HE ER SU PPDU with a 106-tone RU is transmitted with only the MCSO with single spatial stream and the 106-tone RU allocation within the 20 MHz tone plan is fixed as the one that is higher in the frequency.

An ER preamble was also defined in IEEE 802.11be. Both the STF and LTF are boosted with 3 dB, and both the U-SIG1 and the U-SIG2 are repeated twice to improve the performance. The U-SIG-sym-1-R is transmitted with QBPSK, which is used to indicate the extended range mode. However, an ER data format was not introduced in 802.11be.

On the other hand, the IEEE 802.11be draft standard for the PHY introduces EHT duplicate (DUP) mode for a single user transmissions with single spatial stream and LDPC coding in the 6 GHz band as EHT MCS 14. However, it is only defined and used for channel bandwidths of 80/160/320 MHz.

Unfortunately, the current ER preamble configuration is only able to achieve up to 3 dB performance gain. The actual improved performance is only about 1.5 dB. This is not high enough to achieve symmetric performance between uplink and downlink. Therefore, a new ER preamble, which can achieve about 6 or 9 dB better than the existing 20 MHz MCS 0 of OFDM-based 802.11a, is needed future WLAN standards, such as in Wi-Fi 8.

Embodiments disclosed herein provide several different PPDU configurations that can support ER transmission over 40/80/160 even 320 MHz channel and may achieve 6 or 9 dB improvement in performance.

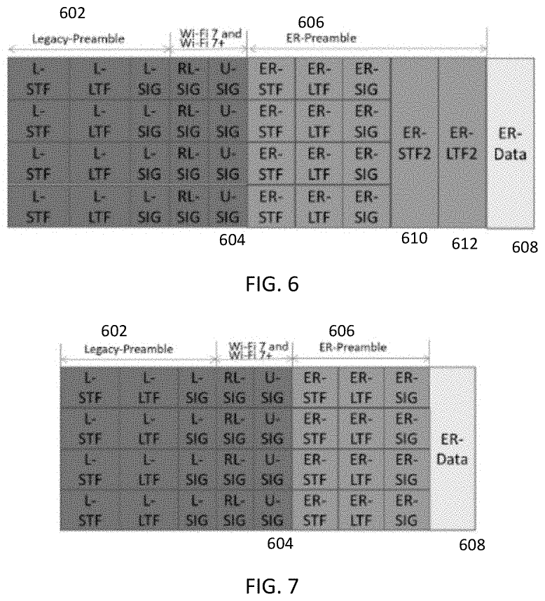

FIG. 6 illustrates an extended range (ER) PPDU, in accordance with some embodiments. FIG. 7 illustrates an ER PPDU, in accordance with some other embodiments. As shown in FIG. 6, the ER preamble includes pre-ER modulated fields and ER modulated fields. The ER preamble includes legacy preamble fields 602 and ER preamble fields 606 including L-STF, L-LTF, L-SIG, RL-SIG, U-SIG 604, ER-STF, ER-LTF and ER-SIG. ER data field 608 may follow the ER-SIG. The ER modulated fields of the ER preamble include ER-STF2 610 and ER-LTF2 612. The pre-ER modulated fields may be duplicated over each 20 MHz subchannels if the transmission is over a channel wider than 20 MHz. Although the content of the pre-ER modulated fields is the same for each 20 MHz subchannel, the transmitted signals can differ by a global phase and/or a cyclic shift delay (CSD). For Wi-Fi 8, the U-SIG field includes two parts, U-SIG-1 and U-SIG-2, and the total length is two OFDM symbols. The encoding and modulation of U-SIG may be the same as that in 802.11be for MU PPDU and TB PPDU. Each U-SIG field may contain 26 data bits and may be set as shown in following table:

| Two parts | | | Number | |
|---|---|---|---|---|
| of U-SIG | Bit | field | of bits | Description |
| U-SIG-1 | B0- | PHY | 3 | Differentiate between |
| | B2 | Version | | different PHY clauses: |
| | | identifier | | Set to 0 for EHT. |
| | | | | Set to 1 for UHR. |
| | | | | Values 2-7 are Validate |
| | B3- | Bandwidth | 3 | Set to 0 for 20 MHz. |
| | B5 | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2. |
| | | | | See definition of 320 MHz-1 |
| | | | | and 320 MHz-2 in 36.3.23.2 |
| | | | | (Channelization for 320 |
| | | | | MHz channel). |
| | | | | Values 6 and 7 are Validate. |
| | B6 | Punctured | | Indicates whether the PPDU |
| | | Channel | | is sent in UL or DL. Set to |
| | | Information | | the TXVECTOR parameter |
| | | | | UPLINK_FLAG. A value of |
| | | | | 1 indicates the PPDU is |
| | | | | addressed to an AP. A value |
| | | | | of 0 indicates the PPDU is |
| | | | | addressed to a non-AP STA. |
| | B7- | BSS Color | 6 | An identifier of the BSS. |
| | B12 | | | Set to the TXVECTOR |
| | | | | parameter BSS_COLOR. |
| | B13- | TXOP | 7 | If the TXVECTOR parameter |
| | B19 | | | TXOP_DURATION is |
| | | | | UNSPECIFIED, set to 127 to |
| | | | | indicate the absence of |
| | | | | duration information. |
| | | | | If the TXVECTOR parameter |
| | | | | TXOP_DURATION is an |
| | | | | integer value, set to a value |
| | | | | less than 127 to indicate |
| | | | | duration information for NAV |
| | | | | setting and protection of the |
| | | | | TXOP as follows: |
| | | | | If the TXVECTOR parameter |
| | | | | TXOP_DURATION |
| | | | | is less than 512, set to 2 × |
| | | | | floor(TXOP_DURATION/8). |
| | | | | Otherwise, set to |
| | | | | 2 × floor((TXOP_ |
| | | | | DURATION − 512)/128) + 1. |
| | B20 | ER | 1 | Indicates whether it is ER |
| | | | | PPDU or not: |
| | | | | Set to 0 for non-ER PPDU |
| | | | | Set to 1 for ER PPDU |
| | B21- | Disregard | 3 | Set to all is and treat as |
| | B24 | | | Disregard |
| | B25 | Validate | 1 | Set to 1 and treat as Validate |

The RL-SIG and the U-SIG with the above setting can be used to differentiate a Wi-Fi 8 UHR ER preamble from a Wi-Fi 7 preamble, Wi-Fi 7 ER preamble and Wi-Fi 8 (non-ER) preamble. The L-STF, L-LTF, L-SIG, RL-SIG and U-SIG of the UHR-ER preamble may not be received by the ER receiver at low RSSI. Therefore, the ER-STF and ER-LTF, which stand for “extend range-STF” and “extended range-LTF”, and are configured to support packet acquisition, fine time/frequency synchronization, channel estimation etc. at low RSSI, are added after the U-SIG.

The ER-SIG stands for extended range SIG, which is used to define the modulation/coding and other transmission parameters to decode the following ER-Data. The ER-SIG may be transmitted with MCS 15 or new defined MCS to support ER application, such as MCS 14. Note: MCS 14 was defined for 80/160/320 MHz bandwidth and used in 6 GHz band only in 802.11be but can be extended to 20/40 MHz and used in 2.4 and 5 GHz band. Or MCS 16, which is BPSK+DCM and dup over each 20 MHz subchannel.

The ER-SIG fields for a UHR ER PPDU may contain the fields listed in following table, or other fields and more than two ER-SIGs may be needed:

| Two | | | | |
|---|---|---|---|---|
| parts of | | | Number | |
| ER-SIG | Bit | field | of bits | Description |
| ER-SIG-1 | B0- | PHY | 3 | Differentiate between |
| | B2 | Version | | different PHY clauses: |
| | | identifier | | Set to 0 for EHT. |
| | | | | Set to 1 for UHR. |
| | | | | Values 2-7 are Validate |
| | B3- | Bandwidth | 3 | Set to 0 for 20 MHz. |
| | B5 | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2. |
| | | | | See definition of 320 |
| | | | | MHz-1 and 320 MHz-2 |
| | | | | in 36.3.23.2 |
| | | | | (Channelization for |
| | | | | 320 MHz channel). |
| | | | | Values 6 and 7 are Validate. |
| | B6 | Punctured | | Indicates whether the |
| | | Channel | | PPDU is sent in UL or |
| | | Information | | DL. Set to the TXVECTOR |
| | | | | parameter UPLINK_FLAG. |
| | | | | A value of 1 indicates the |
| | | | | PPDU is addressed to an AP. |
| | | | | A value of 0 indicates the |
| | | | | PPDU is addressed |
| | | | | to a non-AP STA. |
| | B7- | BSS Color | 6 | An identifier of the BSS. |
| | B12 | | | Set to the TXVECTOR |
| | | | | parameter BSS_COLOR. |
| | B13- | TXOP | 7 | If the TXVECTOR parameter |
| | B19 | | | TXOP_DURATION is |
| | | | | UNSPECIFIED, set to 127 |
| | | | | to indicate the absence of |
| | | | | duration information. |
| | | | | If the TXVECTOR parameter |
| | | | | TXOP_DURATION |
| | | | | is an integer value, set to a |
| | | | | value less than 127 to indicate |
| | | | | duration information for |
| | | | | NAV setting and protection |
| | | | | of the TXOP as follows: |
| | | | | If the TXVECTOR parameter |
| | | | | TXOP_DURATION |
| | | | | is less than 512, set to 2 × |
| | | | | floor(TXOP_DURATION/8). |
| | | | | Otherwise, set to |
| | | | | 2 × floor((TXOP_ |
| | | | | DURATION − 512)/128) + 1. |
| | B20 | ER | 1 | Indicates whether it is ER |
| | | | | PPDU or not: |
| | | | | Set to 0 for non-ER PPDU |
| | | | | Set to 1 for ER PPDU |
| | B21 | GI + LTF | 1 | Indicates the GI duration |
| | | size | | and EHT-LTF size: |
| | | | | Set to 0 to indicate 4x LTF + |
| | | | | 1.6 μs GI. |
| | | | | Set to 1 to indicate 4x LTF + |
| | | | | 3.2 μs GI. |
| | B22- | Number of | 2 | Indicate the number of EHT- |
| | B23 | ER-LTF2 | | LTF symbols: |
| | | symbols | | Set to 0 to indicate 2 EHT- |
| | | | | LTF symbol. |
| | | | | Set to 1 to indicate 4 EHT- |
| | | | | LTF symbols. |
| | | | | Set to 2 to indicate 6 EHT- |
| | | | | LTF symbols. |
| | | | | Set to 3 to indicate 8 EHT- |
| | | | | LTF symbols. |
| | B24 | Disregard | 1 | Set to 1 and treat as Disregard |
| | B25 | Validate | 1 | Set to 1 and treat as Validate |

The version bits B0-B2 in ER-SIG1 together with one version dependent bit such as B20 in ER-SIG1 as shown in above table are used to differentiate a Wi-Fi 8 UHR ER preamble from a Wi-Fi 7 preamble, Wi-Fi 7 ER preamble and Wi-Fi 8 (non-ER) preamble. The GI+LTF size and the number of ER-LTF2 symbols will be indicated in ER-SIG1 or ER-SIG2, and an example is shown in above table. The ER-SIG may also include the spatial reuse, MCS, Length, CRC and Tail field as shown in above table. Potential MCS for ER transmission may include MCSO, 1, 14, 15, or new MCS, such as duplication over each 20 MHz subchannel.

For the Wi-Fi 8 UHR STAs, which do not support ER and can detect the legacy preamble 602 (including the RL-SIG and U-SIG), they will parse and classify it as Wi-Fi 8 UHR ER PPDU and set NAV based on the LENGTH in the L-SIG or TXOP in the U-SIG.

For the Wi-Fi 8 UHR STAs, which support ER and can detect the legacy preamble 602 (including the RL-SIG and U-SIG), they will parse and classify it as Wi-Fi 8 UHR ER PPDU and switch to the ER-STF, ER-LTF, ER-SIG detection. Based on the decoded bandwidth, GI+LTF size and number of ER-LTF2 symbols information, it will do channel estimation through ER-LTF2 to decode the ER-Data. If ER-Data is not for it, it should/may set NAV based on the length field in L-SIG, or TXOP in U-SIG or length field or TXOP field in ER-SIG.

For the Wi-Fi 8 UHR STAB, which support ER, but cannot detect the legacy preamble 602 (including the RL-SIG and U-SIG) due to low RSSI, but can detect the ER preamble 606 (ER-STF, ER-LTF, ER-SIG) will parse and classify it as Wi-Fi 8 UHR ER PPDU after the ER-SIG. If the ER-Data 608 is not for it, it shall/may set NAV based on the length field or TXOP field in the ER-SIG.

In the embodiments illustrated in FIG. 7, the ER preamble includes legacy preamble fields 602 and ER preamble fields 606 including L-STF, L-LTF, L-SIG, RL-SIG, U-SIG 604, ER-STF, ER-LTF and ER-SIG. ER data field 608 may follow the ER-SIG. In these embodiments, each preamble field may be duplicated over each 20 MHz subchannels if the transmission is over a channel with bandwidth wider than 20 MHz as shown in FIG. 7. The configuration of the U-SIG, ER-STF, ER-LTF and ER-SIG may be the same as that illustrated in FIG. 6, however, to decode the ER-Data over wider channel bandwidth, the receiver may need to use the ER-LTFs of the secondary 20 MHz subchannels, and do channel estimation of the secondary 20 MHz subchannels that are loaded with ER-Data after getting the channel bandwidth/puncturing information from the ER-SIG or detecting the active 20 MHz subchannels from the ER-STF or/and ER-LTF. On the other hand, the beamforming can be used starting at the ER-STF. As a result, it cannot be guaranteed that all the nearby ER-receivers refrain from accessing the medium.
Some embodiments are directed to an ultra-high reliable (UHR) station (STA). In these embodiments, the UHR STA may attempt to decode a physical layer protocol data unit (PPDU) the PPDU received on one or more 20 MHz channels. The PPDU may comprise legacy preamble fields followed by a universal signal field (U-SIG). The U-SIG may indicate via a bit (e.g., bit 20 (B20)) whether the PPDU is an extended range (ER) PPDU or a non-ER PPDU. In these embodiments, when the U-SIG indicates that the PPDU is an ER PPDU, the PPDU may also include ER preamble fields following the U-SIG and an ER data field following the ER preamble fields. In these embodiments, when the UHR STA supports ER operations and is able to detect the legacy preamble fields, the UHR STA may classify the PPDU as an ER PPDU based on the legacy preamble fields and the U-SIG and switch to use of the ER preamble fields for decoding the ER data field. In these embodiments, when the UHR STA supports ER operations and is not able to detect the legacy preamble fields (e.g., due to a low received signal strength indication (RSSI), the UHR STA may detect the ER preamble fields, classify the PPDU as an ER PPDU based on the ER preamble fields, and use the ER preamble fields for decoding the ER data field. In these embodiments, the UHR STA may be either a non-AP STA or an AP STA.

In some embodiments, when the UHR STA does not support ER operations and is able to detect the legacy preamble fields, the UHR STA may classify the PPDU as an ER PPDU based on the legacy preamble fields and the U-SIG, and set a network allocation vector (NAV) based on one of a length in a legacy signal field (L-SIG) within the legacy preamble fields and a transmission opportunity (TXOP) duration indicated in the U-SIG.

In some embodiments, for an ER PPDU, the ER preamble fields comprise pre-ER modulated fields followed by ER modulated fields, the pre-ER modulate fields comprising an ER short training field (ER-STF) followed by an ER long training field (ER-LTF) followed by an ER signal field (ER-SIG), the ER modulated fields comprising the ER data field. In these embodiments, the ER modulated fields may also comprise a second ER short training field (ER-STF2) following the ER-SIG field, the ER-STF2 followed by a second ER long training field (ER-LTF2). In these embodiments, for the UHR STA that supports ER operations and has classified the PPDU as an ER PPDU, the UHR STA may also decode the ER-SIG to determine a bandwidth for the ER-STF2 and the ER LTF2, and the ER data field and perform a channel estimation for the bandwidth using the ER-STF2 and the ER LTF2 fields. The UHR STA may also decode the ER data field over the bandwidth using the channel estimation.

In these embodiments, the ER-STF and ER-LTF may be designed to support packet acquisition, fine time/frequency synchronization, channel estimation etc. at low RSSI. The ER-SIG may define the modulation/coding and other transmission parameters used to decode the ER data field that follows. The ER-SIG may be transmitted with a modulation and coding scheme, for example, MCS 14, MCS 15, or MCS 16, although the scope of the embodiments is not limited in this respect.

In some embodiments, for an ER PPDU, the ER preamble fields may comprise pre-ER modulated fields followed by ER modulated fields. The pre-ER modulate fields may comprise an ER short training field (ER-STF) followed by an ER long training field (ER-LTF) followed by an ER signal field (ER-SIG). The ER modulated fields may comprise at least the ER data field. In these embodiments, for the UHR STA that supports ER operations and has classified the PPDU as an ER PPDU, the UHR STA may decode the ER-SIG to determine a bandwidth for the ER data field, and perform a channel estimation for the bandwidth using the ER-LTFs for each of the one or more 20 MHz channels of the bandwidth (i.e., since there are no ER-STF2 and the ER LTF2 fields that cover the entire bandwidth).

In some embodiments, for an ER PPDU that is transmitted over a wideband channel comprising more than one 20 MHz channel, the pre-ER modulated fields may be duplicated over each 20 MHz channel. In these embodiments, the ER modulated fields and the ER data field may comprise a wideband transmission over the wideband channel. In these embodiments, the UHR STA may decode one or more bits (e.g., bits 0-2 (B0-B2)) of the U-SIG to determine whether the PPDU is configured for an extremely high throughput (EHT) transmission or a UHR transmission. In these embodiments, UHR transmissions may be configured in accordance with a Wi-Fi 8 standard and EHT transmissions may be configured in accordance with a Wi-Fi 7 standard.

In some embodiments, for an ER PPDU that is configured for a UHR transmission (i.e., a UHR ER PPDU), the UHR STA may decode a bit (e.g., bit 21 (B21)) of the U-SIG to determine a guard interval (GI) duration and a size of the ER-LTF (i.e., the ER-LTF size). In some embodiments, the guard interval duration and the size of the ER-LTF is indicated by the U-SIG to be one of a 4×LTF size with a 1.6 us GI duration and a 4×LTF size with a 3.2 us GI duration. In these embodiments, a longer GI duration may be used when the delay spread of the channel is larger, for example outdoors.

In some embodiments, for an ER PPDU that is configured for a UHR transmission (i.e., a UHR ER PPDU), the UHR STA may decode one or more bits (e.g., bits 22-23 (B22-B23)) of the U-SIG to determine a number of symbols in the ER-LTF2 field. In some embodiments, the number of symbols in the ER-LTF2 field indicated by the U-SIG may comprise one of 2, 4, 6 or 8 EHT-LTF symbols. In these embodiments, more EHT-LTF symbols may be used when the RSSI is lower allowing the STA to obtain a better channel state information estimation and an improved time/frequency offset estimation, although the scope of the embodiments is not limited in this respect.

In some embodiments, the UHR STA may include memory configured to store information decoded from the U-SIG and processing circuitry comprising a baseband processor, although the scope of the embodiments is not limited in this respect.

Some embodiments are directed to a UHR STA configured to encode a physical layer protocol data unit (PPDU) for transmission (see FIGS. 6 and 7). The PPDU may comprise legacy preamble fields 602 followed by a universal signal field (U-SIG) 604. For an extended range (ER) transmission, the UHR STA may encode the U-SIG to indicate via a bit (e.g., bit 20 (B20)) whether the PPDU is an ER PPDU or a non-ER PPDU. When the U-SIG is encoded to indicate that the PPDU is an ER PPDU, the UHR STA may further encode the PPDU to include ER preamble fields 606 following the U-SIG and an ER data field 608 following the ER preamble fields. In these embodiments, the ER preamble fields may comprise pre-ER modulated fields followed by ER modulated fields. The pre-ER modulate fields may comprise an ER short training field (ER-STF) followed by an ER long training field (ER-LTF) followed by an ER signal field (ER-SIG). The ER modulated fields may comprise at least the ER data field. In these embodiments, the UHR STA may transmit the encoded PPDU on one or more 20 MHz channels.

In these embodiments, the ER-STF and ER-LTF of an ER PPDU may be configured to support packet acquisition, fine time/frequency synchronization, channel estimation, among other things, in low received signal strength situations.

In some embodiments, the ER modulated fields may further comprise a second ER short training field (ER-STF2) 610 following the ER-SIG field, the ER-STF2 followed by a second ER long training field (ER-LTF2) 612. An example of this is illustrated in FIG. 6. In these embodiments, the ER-SIG is encoded to indicate the bandwidth for the ER-STF2 and the ER LTF2, and the ER data field. Accordingly, the station receiving the PPDU may use the ER-STF2 and the ER LTF2 fields for performing a channel estimation over the bandwidth which may be used for decoding the ER data field. The bandwidth may comprise one or more 20 MHz channels and may be as great as 320 MHz or even 640 MHz.

In some embodiments, for a wideband transmission of an ER PPDU over a wideband channel comprising more than one 20 MHz channel, the UHR STA may be configured to duplicate the pre-ER modulated fields for duplicate transmission over each 20 MHz channel, and configure the ER modulated fields and the ER data field for a wideband transmission over the wideband channel.

In some embodiments, the UHR STA may encode the U-SIG via one or more bits (e.g., bits 0-2 (B0-B2)) to indicate whether the PPDU is configured for an extremely high throughput (EHT) transmission or a UHR transmission. For an ER PPDU that is configured for a UHR transmission (i.e., a UHR ER PPDU), the U-SIG may further be encoded to indicate via a bit (e.g., bit 21 (B21)) a guard interval (GI) duration and a size of the ER-LTF (i.e., the ER-LTF size). In these embodiments, the guard interval duration and the size of the ER-LTF may be indicated by the U-SIG to be one of a 4×LTF size with a 1.6 us GI duration and a 4×LTF size with a 3.2 us GI duration.

In some embodiments, for an ER PPDU that is configured for a UHR transmission (i.e., a UHR ER PPDU), the U-SIG may also be encoded to indicate via one or more bits (e.g., bits 22-23 (B22-B23)) a number of symbols in the ER-LTF2 field. In some embodiments, the number of symbols in the ER-LTF2 field indicated by the U-SIG may comprise one of 2, 4, 6 or 8 EHT-LTF symbols. In these embodiments, a greater number of the EHT-LTF symbols may be included in the ER-LTF2 for a lower received signal strength indication (RSSI), although the scope of the embodiments is not limited in this respect.

In some embodiments, when the U-SIG filed indicates that the PPDU is a non-ER PPDU and configured for an EHT transmission or an ER PPDU configured for an EHT transmission, the PPDU may be encoded to include EHT modulated fields comprising EHT preamble fields following the U-SIG filed and an EHT data field following the EHT preamble. In these embodiments, the EHT preamble fields may comprise an EHT signal (EHT-SIG) followed by an EHT short training field (EHT-STF) followed by an EHT long training field (EHT LTF). For a wideband transmission of the EHT PPDU over a wideband channel comprising more than one 20 MHz channel, the UHR STA may configure the EHT modulated fields including the EHT data field a wideband transmission over the wideband channel.

In some embodiments, the legacy preamble fields may comprise a non-high throughput (HT) Short Training field (L-STF) followed by a non-HT Long Training field (L-LTF) followed by a non-HT SIGNAL field (L-SIG) followed by a repeated non-HT SIGNAL field (L-SIG). In some embodiments, the non-HT fields may be referred to as legacy fields, although the scope of the embodiments is not limited in this respect.

Some embodiments are directed to a method performed by processing circuitry of an ultra-high reliable (UHR) STA. The method may include encoding a physical layer protocol data unit (PPDU) for transmission comprising legacy preamble fields 602 followed by a universal signal field (U-SIG) 604. For an extended range (ER) transmission, the method may include encoding the U-SIG to indicate whether the PPDU is an ER PPDU or a non-ER PPDU. In these embodiments, when the U-SIG is encoded to indicate that the PPDU is an ER PPDU, the method further comprises further encoding the PPDU to include ER preamble fields 606 following the U-SIG and an ER data field 608 following the ER preamble fields. In these embodiments, the ER preamble fields may comprise pre-ER modulated fields followed by ER modulated fields. The method may also include configuring the UHR STA to transmit the encoded PPDU on one or more 20 MHz channels.

In some embodiments, a physical layer protocol data unit may be a physical layer conformance procedure (PLCP) protocol data unit (PPDU). In some embodiments, the AP and STAs may communicate in accordance with one of the IEEE 802.11 standards. IEEE 802.11-2016 is incorporated herein by reference. IEEE P802.11-REVmd/D2.4, August 2019, and IEEE draft specification IEEE P802.11ax/D5.0, October 2019 are incorporated herein by reference in their entireties. In some embodiments, the AP and STAs may be directional multi-gigabit (DMG) STAs or enhanced DMG (EDMG) STAs configured to communicate in accordance with IEEE 802.11ad standard or IEEE draft specification IEEE P802.11ay, February 2019, which is incorporated herein by reference.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

What is claimed is:

1. An apparatus of an ultra-high reliable (UHR) station (STA), the apparatus comprising: processing circuitry; and memory, wherein the processing circuitry is configured to attempt to decode a physical layer protocol data unit (PPDU), the PPDU received on one or more 20 MHz channels, the PPDU comprising legacy preamble fields followed by a universal signal field (U-SIG), the U-SIG indicating whether the PPDU is an extended range (ER) PPDU or a non-ER PPDU,
wherein when the U-SIG indicates that the PPDU is an ER PPDU, the PPDU further comprises ER preamble fields following the U-SIG and an ER data field following the ER preamble fields,
wherein when the UHR STA supports ER operations and is able to detect the legacy preamble fields, the processing circuitry is configured to: classify the PPDU as an ER PPDU based on the legacy preamble fields and the U-SIG, and switch to use of the ER preamble fields for decoding the ER data field, and
wherein when the UHR STA supports ER operations and is not able to detect the legacy preamble fields, the processing circuitry is configured to: detect the ER preamble fields, classify the PPDU as an ER PPDU based on the ER preamble fields, and use the ER preamble fields for decoding the ER data field.

2. The apparatus of claim 1, wherein when the UHR STA does not support ER operations and is able to detect the legacy preamble fields, the processing circuitry is configured to: classify the PPDU as an ER PPDU based on the legacy preamble fields and the U-SIG, and set a network allocation vector (NAV) based on one of a length in a legacy signal field (L-SIG) within the legacy preamble fields and a transmission opportunity (TXOP) duration indicated in the U-SIG.

3. The apparatus of claim 2, wherein for an ER PPDU, the ER preamble fields comprise pre-ER modulated fields followed by ER modulated fields, the pre-ER modulate fields comprising an ER short training field (ER-STF) followed by an ER long training field (ER-LTF) followed by an ER signal field (ER-SIG), the ER modulated fields comprising the ER data field,
wherein the ER modulated fields further comprise a second ER short training field (ER-STF2) following the ER-SIG field, the ER-STF2 followed by a second ER long training field (ER-LTF2), and
wherein for the UHR STA that supports ER operations and has classified the PPDU as an ER PPDU, the processing circuitry is further configured to:
decode the ER-SIG to determine a bandwidth for the ER-STF2 and the ER LTF2, and the ER data field;
perform a channel estimation for the bandwidth using the ER-STF2 and the ER LTF2 fields; and
decode the ER data field over the bandwidth using the channel estimation.

4. The apparatus of claim 2, wherein for an ER PPDU, the ER preamble fields comprise pre-ER modulated fields followed by ER modulated fields, the pre-ER modulate fields comprising an ER short training field (ER-STF) followed by an ER long training field (ER-LTF) followed by an ER signal field (ER-SIG), the ER modulated fields comprising the ER data field,
wherein for the UHR STA that supports ER operations and has classified the PPDU as an ER PPDU, the processing circuitry is further configured to:
decode the ER-SIG to determine a bandwidth for the ER data field;
perform a channel estimation for the bandwidth using the ER-LTFs for each of the one or more 20 MHz channels of the bandwidth.

5. The apparatus of claim 3, wherein for an ER PPDU that is transmitted over a wideband channel comprising more than one 20 MHz channel, the pre-ER modulated fields are duplicated over each 20 MHz channel, and the ER modulated fields and the ER data field comprise a wideband transmission over the wideband channel,
wherein the processing circuitry is further configured to decode the U-SIG to determine whether the PPDU is configured for an extremely high throughput (EHT) transmission or a UHR transmission.

6. The apparatus of claim 5, wherein for an ER PPDU that is configured for a UHR transmission, the processing circuitry is further configured to decode the U-SIG to determine a guard interval (GI) duration and a size of the ER-LTF.

7. The apparatus of claim 6, wherein the guard interval duration and the size of the ER-LTF is indicated by the U-SIG to be one of a 4×LTF size with a 1.6 us GI duration and a 4×LTF size with a 3.2 us GI duration.

8. The apparatus of claim 5, wherein for an ER PPDU that is configured for a UHR transmission, the processing circuitry is further configured to decode the U-SIG to determine a number of symbols in the ER-LTF2 field.

9. The apparatus of claim 8, wherein the number of symbols in the ER-LTF2 field indicated by the U-SIG comprises one of 2, 4, 6 or 8 EHT-LTF symbols.

10. The apparatus of claim 5, wherein the memory is configured to store information decoded from the U-SIG, and
wherein the processing circuitry comprises a baseband processor.

11. An apparatus of an ultra-high reliable (UHR) station (STA), the apparatus comprising: processing circuitry; and memory, wherein the processing circuitry is configured to:
encode a physical layer protocol data unit (PPDU) for transmission, the PPDU comprising legacy preamble fields followed by a universal signal field (U-SIG), wherein for an extended range (ER) transmission, the processing circuitry is configured to encode the U-SIG to indicate whether the PPDU is an ER PPDU or a non-ER PPDU,
wherein when the U-SIG indicates that the PPDU is an ER PPDU, the PPDU is further encoded to include ER preamble fields following the U-SIG and an ER data field following the ER preamble fields,
wherein the ER preamble fields comprise pre-ER modulated fields followed by ER modulated fields, the pre-ER modulate fields comprising an ER short training field (ER-STF) followed by an ER long training field (ER-LTF) followed by an ER signal field (ER-SIG), the ER modulated fields comprising the ER data field; and
configure the UHR STA to transmit the encoded PPDU on one or more 20 MHz channels.

12. The apparatus of claim 11 wherein the ER modulated fields further comprise a second ER short training field (ER-STF2) following the ER-SIG field, the ER-STF2 followed by a second ER long training field (ER-LTF2).

13. The apparatus of claim 12, wherein for a wideband transmission of an ER PPDU over a wideband channel comprising more than one 20 MHz channel, the processing circuitry is configured to:
configure the UHR STA to:
duplicate the pre-ER modulated fields for transmission over each 20 MHz channel; and
configure the ER modulated fields and the ER data field for a wideband transmission over the wideband channel.

14. The apparatus of claim 13, wherein the processing circuitry is further configured to encode the U-SIG to indicate whether the PPDU is configured for an extremely high throughput (EHT) transmission or a UHR transmission,
wherein for an ER PPDU that is configured for a UHR transmission, the U-SIG is further encoded to indicate a guard interval (GI) duration and a size of the ER-LTF.

15. The apparatus of claim 14, wherein for an ER PPDU that is configured for a UHR transmission, the U-SIG is further encoded to indicate a number of symbols in the ER-LTF2 field.

16. The apparatus of claim 15, wherein the number of symbols in the ER-LTF2 field indicated by the U-SIG comprises one of 2, 4, 6 or 8 EHT-LTF symbols, and
wherein a greater number of the EHT-LTF symbols are included in the ER-LTF2 for a lower received signal strength indication (RSSI).

17. The apparatus of claim 15, wherein when the U-SIG filed indicates that the PPDU is one of a non-ER PPDU and an ER-PPDU and is configured for an EHT transmission (EHT PPDU), the PPDU is encoded to include EHT modulated fields comprising EHT preamble fields following the U-SIG filed and an EHT data field following the EHT preamble,
the EHT preamble fields comprising an EHT signal (EHT-SIG) followed by an EHT short training field (EHT-STF) followed by an EHT long training field (EHT LTF), and
wherein for a wideband transmission of the EHT PPDU over a wideband channel comprising more than one 20 MHz channel, the processing circuitry is to configure the EHT modulated fields including the EHT data field a wideband transmission over the wideband channel.

18. The apparatus of claim 17, wherein the legacy preamble fields comprise a non-high throughput (HT) Short Training field (L-STF) followed by a non-HT Long Training field (L-LTF) followed by a non-HT SIGNAL field (L-SIG) followed by a repeated non-HT SIGNAL field (L-SIG).

19. A method performed by processing circuitry of an ultra-high reliable (UHR) STA, the method comprising:
encoding a physical layer protocol data unit (PPDU) for transmission, the PPDU comprising legacy preamble fields followed by a universal signal field (U-SIG), wherein for an extended range (ER) transmission, the processing circuitry is configured to encode the U-SIG to indicate whether the PPDU is an ER PPDU or a non-ER PPDU,
wherein when the U-SIG indicates that the PPDU is an ER PPDU, the method further comprises further encoding the PPDU to include ER preamble fields following the U-SIG and an ER data field following the ER preamble fields,
wherein the ER preamble fields comprise pre-ER modulated fields followed by ER modulated fields, the pre-ER modulate fields comprising an ER short training field (ER-STF) followed by an ER long training field (ER-LTF) followed by an ER signal field (ER-SIG), the ER modulated fields comprising the ER data field; and
configuring the UHR STA to transmit the encoded PPDU on one or more 20 MHz channels.

20. The method of claim 19, wherein the ER modulated fields further comprise a second ER short training field (ER-STF2) following the ER-SIG field, the ER-STF2 followed by a second ER long training field (ER-LTF2), and
wherein for a wideband transmission of an ER PPDU over a wideband channel comprising more than one 20 MHz channel, the method comprises:
duplicating the pre-ER modulated fields for transmission over each 20 MHz channel; and
configuring the ER modulated fields and the ER data field for a wideband transmission over the wideband channel.
